(19) United States
(12) Patent Application Publication
(10) Pub. No.: US 2022/0080981 A1
(43) Pub. Date: Mar. 17, 2022

(54) CALIBRATION METHOD AND APPARATUS, ELECTRONIC DEVICE, AND COMPUTER READABLE STORAGE MEDIUM

(71) Applicant: Shanghai SenseTime Lingang Intelligent Technology Co., Ltd., Shanghai (CN)

(72) Inventors: Xin LI, Shanghai (CN); Yuqian LIU, Shanghai (CN)

(21) Appl. No.: 17/527,281

(22) Filed: Nov. 16, 2021

Related U.S. Application Data
(63) Continuation of application No. PCT/CN2021/090361, filed on Apr. 27, 2021.

(30) Foreign Application Priority Data
Sep. 16, 2020 (CN) 202010972920.5

(51) Int. Cl. B60W 40/12; B60W 40/10; B60W 40/09

(52) U.S. Cl. CPC B60W 40/12; B60W 40/09; B60W 40/10

(57) ABSTRACT

A calibration method and apparatus, and a computer readable storage medium are provided. The calibration method includes: obtaining first vehicle driving parameter information outputted by a vehicle-mounted sensor and second vehicle driving parameter information outputted by an integrated navigation device during driving of a target vehicle; and determining calibration parameter information of the vehicle-mounted sensor according to first vehicle driving parameter values of a plurality of first collection time points in the first vehicle driving parameter information and second vehicle driving parameter values of a plurality of second collection time points in the second vehicle driving parameter information.

### CROSS-REFERENCE TO RELATED APPLICATIONS

This is a continuation application of International Patent Application No. PCT/CN2021/090361, filed on Apr. 27, 2021, which claims priority to Chinese Patent Application No. 202010972920.5, filed on Sep. 16, 2020. The disclosures of International Patent Application No. PCT/CN2021/090361 and Chinese Patent Application No. 202010972920.5 are hereby incorporated by reference in their entireties.

### BACKGROUND

A vehicle-mounted sensor for measuring vehicle driving data, such as a wheel-type odometer and a yaw rate sensor, is generally integrated on a vehicle chassis and used for sensing a motion state of the vehicle, thereby improving the safety and stability of the vehicle. An automatic driving vehicle may obtain the wheel velocity data of the wheel-type odometer and the yaw rate data of the yaw rate sensor through a Controller Area Network (CAN) bus, so as to reckon the current position of the vehicle through integration, thereby obtaining accurate relative positioning accuracy.

When the vehicle driving data (an angular velocity and a linear velocity of the vehicle) is measured through the vehicle-mounted sensor, it is required to determine calibration parameter information of the vehicle-mounted sensor, and initial vehicle driving data measured by the sensor is calibrated through the calibration parameter information, so as to obtain outputted vehicle driving data. Therefore, the accuracy of the calibration parameter information affects the accuracy of the obtained vehicle driving data, thereby affecting the accuracy of vehicle positioning. Generally, the calibration parameter information of the vehicle-mounted sensor is determined before the vehicle is shipped from a factory, but with the increase of usage time, wear would occur to the vehicle-mounted sensor, and the wear and the influence of an environment change enable the calibration parameter information to be inaccurate. Therefore, in actual use, it is required to update the calibration parameter information of the vehicle-mounted sensor in time.

### SUMMARY

In view of the above, embodiments of the disclosure at least provide a calibration scheme, and in particular a calibration method and apparatus, an electronic device, and a computer readable storage medium, which may improve the accuracy of a calibration result while simplifying a calibration process of a vehicle-mounted sensor.

In a first aspect, embodiments of the disclosure provide a calibration method. The method includes the following operations.

First vehicle driving parameter information outputted by a vehicle-mounted sensor and second vehicle driving parameter information outputted by a integrated navigation device are obtained during driving of a target vehicle.

Calibration parameter information of the vehicle-mounted sensor is determined according to first vehicle driving parameter values of a plurality of first collection time points in the first vehicle driving parameter information and second vehicle driving parameter values of a plurality of second collection time points in the second vehicle driving parameter information.

By using the vehicle driving parameter information outputted by the integrated navigation device to calibrate the vehicle driving parameter information of the vehicle-mounted sensor, the embodiments of this disclosure have no special requirement for a calibration place, and do not require the vehicle to travel according to a specific travel trajectory, thereby simplifying the calibration process of the vehicle-mounted sensor and improving the calibration efficiency. In addition, it is not required to consider an error caused by mismatch of the travel trajectory of the vehicle and a set trajectory, thereby further improving the accuracy of the calibration result.

In a second aspect, embodiments of the disclosure provide a calibration apparatus. The calibration apparatus includes an obtaining portion and a determining portion.

The obtaining portion is configured to obtain first vehicle driving parameter information outputted by a vehicle-mounted sensor and second vehicle driving parameter information outputted by an integrated navigation device during driving of a target vehicle.

The determining portion is configured to determine calibration parameter information of the vehicle-mounted sensor according to first vehicle driving parameter values of a plurality of first collection time points in the first vehicle driving parameter information and second vehicle driving parameter values of a plurality of second collection time points in the second vehicle driving parameter information.

In a third aspect, embodiments of the disclosure provide an electronic device, including a processor, a memory, and a bus. The memory stores machine readable instructions executable by the processor. When the electronic device runs, the processor communicates with the memory through the bus. The machine readable instructions are executed by the processor to implement operations in the first aspect or any possible implementation mode thereof.

In a fourth aspect, embodiments of the disclosure provide a computer readable storage medium having a computer program stored thereon. The computer program is executed by a processor to implement operations in any implementation mode of the first aspect.

In a fifth aspect, embodiments of the disclosure provide a computer program, including a computer readable code. The computer readable code runs in a computer device to enable a processor in the computer device to implement operations in any implementation mode of the first aspect.

Descriptions for the effects of the foregoing apparatus, the electronic device, and the computer readable storage medium may make reference to the description for the method, which are not elaborated herein.

To enable the above objectives, features, and advantages of the disclosure to be more apparent and understandable, preferred embodiments are specially exemplified below in combination with the accompanying drawings for making the following detailed description.

### BRIEF DESCRIPTION OF THE DRAWINGS

To describe the technical solutions of the embodiments of the disclosure more clearly, the accompanying drawings required to be used in the embodiments will be simply introduced below. The accompanying drawings, which are incorporated in and constitute a part of this specification, illustrate embodiments consistent with the disclosure and, together with the specification, serve to illustrate the technical solutions of the disclosure. It should be understood that the following accompanying drawings merely illustrate some embodiments of the disclosure, and should not be considered to limit the scope. Other relevant accompanying drawings may further be obtained by those of ordinary skill in the art according to these drawings without creative work.

FIG. 1A is a schematic structural composition diagram of a calibration system provided by an embodiment of the disclosure.

FIG. 1B is a schematic flowchart of a calibration method provided by an embodiment of the disclosure.

FIG. 2 is a schematic flowchart of determining calibration parameter information of a vehicle-mounted sensor provided by an embodiment of the disclosure.

FIG. 3 is a schematic flowchart of determining a timestamp offset value of a vehicle-mounted sensor with respect to an integrated navigation device provided by an embodiment of the disclosure.

FIG. 4A is a schematic flowchart of determining difference information between first vehicle driving parameter information and second vehicle driving parameter information provided by an embodiment of the disclosure.

FIG. 4B is a schematic diagram of a function curve of a cost equation provided by an embodiment of the disclosure.

FIG. 4C is a schematic diagram of an iterative process provided by an embodiment of the disclosure.

FIG. 5 is a specific schematic flowchart of determining calibration parameter information of a vehicle-mounted sensor provided by an embodiment of the disclosure.

FIG. 6 is a schematic structural diagram of a calibration apparatus provided by an embodiment of the disclosure.

FIG. 7 is a schematic structural diagram of an electronic device provided by an embodiment of the disclosure.

### DETAILED DESCRIPTION

To enable the objectives, technical solutions, and advantages of the disclosure more apparent, the technical solutions in the embodiments of the disclosure are described clearly and completely below in combination with the accompanying drawings in the embodiments of the disclosure. It is apparent that the described embodiments are merely a part of the embodiments of the disclosure but not all. Generally, the components of the embodiments of the disclosure that are described and shown in the accompanying drawings herein may be arranged and designed in various different configurations. Therefore, the following detailed description of the embodiments of the disclosure provided in the accompanying drawings is not intended to limit the claimed scope, but only represents the selected embodiments of the disclosure. Based on the embodiments of the disclosure, all other embodiments obtained by those skilled in the art without creative work shall fall within the scope of protection of the disclosure.

The accurate positioning of an automatic driving vehicle can be implemented using sensor data outputted by a vehicle-mounted sensor. For example, the current position of the vehicle is reckoned by integrating linear velocity data and angular velocity data. Initial sensor data collected by the vehicle-mounted sensor generally needs to be subjected to the calibration of calibration parameter information, and then is used for determining positioning information. Thus, the accuracy of the calibration parameter information used for calibrating the sensor data directly affects the accuracy of positioning.

Generally, a calibration manner based on a fixed place and a fixed travel trajectory is more restrictive, in which the vehicle is required to be driven to the fixed place and calibrated through a calibration platform at the fixed place. The process is complex, and the calibration parameter information of the vehicle-mounted sensor cannot be updated in time. Therefore, the embodiments of the disclosure provide a calibration method and apparatus, an electronic device, and a computer readable storage medium. By introducing an integrated navigation device with a high accuracy to obtain vehicle driving parameter information as a calibration result, the disclosure has no special requirement for a calibration place and a vehicle travel trajectory, thereby simplifying the calibration process of the vehicle-mounted sensor, automatically completing calibration, and improving the calibration efficiency. Since it is not required to consider an error caused by the mismatch of the travel trajectory of the vehicle and a set trajectory, the accuracy of the calibration result can be further improved.

In order to facilitate understanding the embodiments, a calibration method provided by the embodiments of the disclosure is first introduced in details. The calibration method provided by the embodiments of the disclosure generally is performed by a processing apparatus having a data processing capability. The processing apparatus may be an independent device, and may also be deployed on a vehicle terminal or a cloud platform server terminal, which is not limited in the embodiments of the disclosure.

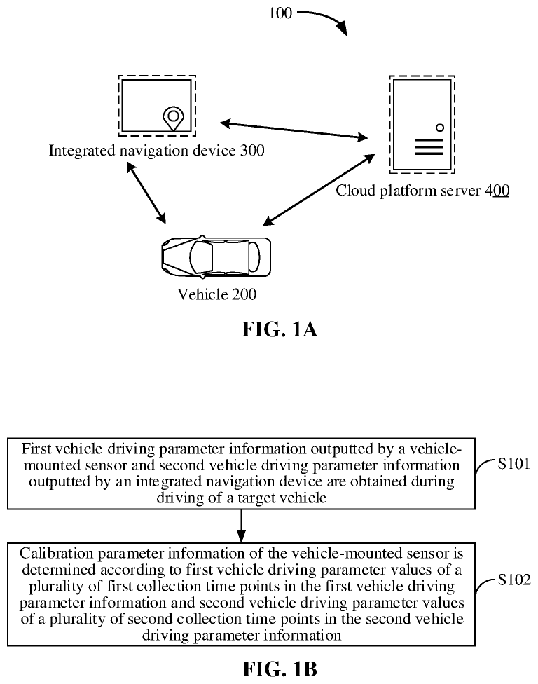

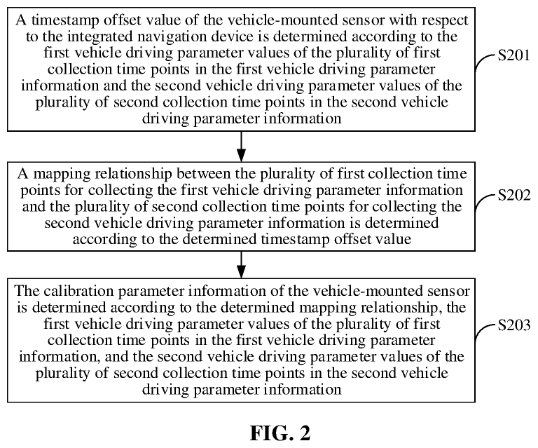

Exemplarily, an embodiment of the disclosure provides a schematic structural diagram of a calibration system. As shown in FIG. 1A, the calibration system 100 includes a vehicle 200, an integrated navigation device 300, and a cloud platform server 400. The vehicle 200, the integrated navigation device 300, and the cloud platform server 400 communicate with each other. The vehicle-mounted sensor is provided on the vehicle 200. The cloud platform server 400 may obtain the first vehicle driving parameter information of the vehicle 200 collected by the vehicle-mounted sensor from the vehicle 200, and the second vehicle driving parameter information from the integrated navigation device consisting of an Inertial measurement unit (IMU) and a Global Positioning System (GPS). The calibration parameter information of the vehicle-mounted sensor is determined according to the first vehicle driving parameter information and second vehicle driving parameter information.

Referring to FIG. 1B, FIG. 1B is a schematic flowchart of a calibration method provided by an embodiment of the disclosure. The following operations in S101 and S102 are specifically included.

In S101, first vehicle driving parameter information outputted by a vehicle-mounted sensor and second vehicle driving parameter information outputted by an integrated navigation device are obtained during driving of a target vehicle.

The first vehicle driving parameter information and the second vehicle driving parameter information respectively include vehicle driving parameter values that are collected at different collection time points.

In the embodiments of the disclosure, the target vehicle may be an automatic driving vehicle, may also be an ordinary vehicle, and further may be a movable device, such as a mobile robot, which is not limited in the embodiment of the disclosure.

In S102, calibration parameter information of the vehicle-mounted sensor is determined according to first vehicle driving parameter values of a plurality of first collection time points in the first vehicle driving parameter information and second vehicle driving parameter values of a plurality of second collection time points in the second vehicle driving parameter information.

The foregoing operations in S101 and S102 are respectively described in details below.

In S101, during traveling of the target vehicle, the vehicle-mounted sensor on the target vehicle may collect the vehicle driving parameter information during the traveling of the vehicle. The vehicle-mounted sensor may be a sensor that collects the driving velocity of the target vehicle, such as a wheel-type odometer and a yaw rate sensor integrated on the vehicle chassis. The wheel-type odometer may record a linear velocity value of the target vehicle, and the yaw rate sensor may record an angular velocity value of the target vehicle.

The integrated navigation device may be an integrated navigation device consisting of an IMU and a GPS, and accurately collect the vehicle driving parameter information generated during the traveling of the target vehicle. Therefore, the vehicle driving parameter information collected by the integrated navigation device may be used as the calibration result, so as to determine the calibration parameter information of the vehicle-mounted sensor. Of course, the integrated navigation device may also be another integrated navigation device that can accurately collect the vehicle driving parameter information of the target vehicle during traveling, which is not limited herein.

In the embodiments of the disclosure, during driving of the target vehicle, the vehicle driving parameter information collected by the vehicle-mounted sensor may be obtained through a controller area network (CAN) bus. In order to distinguish from the vehicle driving parameter information obtained by the integrated navigation device, the vehicle driving parameter information collected by the vehicle-mounted sensor and obtained by the CAN bus is marked as the first vehicle driving parameter information, and the vehicle driving parameter information collected by the integrated navigation device is marked as the second vehicle driving parameter information.

In order to obtain accurate calibration parameter information, it is generally needed to perform determination through a plurality of vehicle driving parameter information. That is, the first vehicle driving parameter information and the second vehicle driving parameter information in the embodiments of the disclosure respectively include vehicle driving parameter values that are collected at a plurality of collection time points. In some embodiments, the vehicle-mounted sensor and the integrated navigation device may collect the vehicle driving parameter values according to the same set time interval, and thus, the vehicle driving parameter values collected at a plurality of time points may be obtained. When the vehicle driving parameter information includes a linear velocity value and a yaw rate value, the first vehicle driving parameter information collected by the vehicle-mounted sensor includes linear velocity values collected at the plurality of time points and angular velocity values collected at the plurality of time points, and the second vehicle driving parameter information collected by the integrated navigation device also includes linear velocity values collected at the plurality of time points and angular velocity values collected at the plurality of time points.

In the embodiments of the disclosure, the driving process of the target vehicle may include actual conditions such as vehicle turning, vehicle acceleration, and vehicle deceleration, so that the first vehicle driving parameter information and the second vehicle driving parameter information are richer and more diverse, thereby improving the accuracy of calibration.

In S102, after the first vehicle driving parameter information and the second vehicle driving parameter information are obtained, the calibration parameter information of the vehicle-mounted sensor may be determined according to the first vehicle driving parameter values of the plurality of first collection time points in the first vehicle driving parameter information and the second vehicle driving parameter values of the plurality of second collection time points in the second vehicle driving parameter information.

In the embodiments of the disclosure, by introducing the integrated navigation device to obtain the vehicle driving parameter information as the calibration result, the calibration of the vehicle-mounted sensor during the daily driving of the vehicle can be achieved through the output result of the integrated navigation device and initial vehicle driving parameter information collected by the vehicle-mounted sensor, so as to simplify the calibration process of the vehicle-mounted sensor and improve the accuracy of the calibration parameter information, thereby facilitating accurate positioning of the target vehicle.

In S102, when the calibration parameter information of the vehicle-mounted sensor is determined according to the first vehicle driving parameter values of the plurality of first collection time points in the first vehicle driving parameter information and the second vehicle driving parameter values of the plurality of second collection time points in the second vehicle driving parameter information, it is required to determine the second vehicle driving parameter value of the second collection time point corresponding to the first vehicle driving parameter value of each first collection time point, so that each first vehicle driving parameter value is used as an object to be calibrated, and the second vehicle driving parameter value corresponding to the first vehicle driving parameter value is used as the calibration result, to obtain the calibration parameter information.

During the implementation, first, timestamp alignment may be performed on the first vehicle driving parameter information and the second vehicle driving parameter information, i.e., the second collection time point corresponding to each first collection time point is determined, thereby avoiding an error caused by timestamp misalignment, and improving the accuracy of calibration. The timestamp alignment herein is not simply performing alignment on the first collection time point and the second collection time point with a shortest time interval, but determining a timestamp offset value that minimizes a difference between the first vehicle driving parameter information and the second vehicle driving parameter information. The first vehicle driving parameter information and the second vehicle driving parameter information are aligned according to the timestamp offset value.

As shown in FIG. 2, in S102, the implementation of determining the calibration parameter information of the vehicle-mounted sensor according to the first vehicle driving parameter values of the plurality of first collection time points in the first vehicle driving parameter information and the second vehicle driving parameter values of the plurality of second collection time points in the second vehicle driving parameter information may include the following operations in S201 to S203.

In S201, a timestamp offset value of the vehicle-mounted sensor with respect to the integrated navigation device is determined according to the first vehicle driving parameter values of the plurality of first collection time points in the first vehicle driving parameter information and the second vehicle driving parameter values of the plurality of second collection time points in the second vehicle driving parameter information.

In S202, a mapping relationship between the plurality of first collection time points for collecting the first vehicle driving parameter information and the plurality of second collection time points for collecting the second vehicle driving parameter information is determined according to the determined timestamp offset value.

A difference value between the first collection time point and the second collection time point with a mapping relationship is equal to the timestamp offset value.

In S203, the calibration parameter information of the vehicle-mounted sensor is determined according to the determined mapping relationship, the first vehicle driving parameter values of the plurality of first collection time points in the first vehicle driving parameter information, and the second vehicle driving parameter values of the plurality of second collection time points in the second vehicle driving parameter information.

The operations in S201 to S203 are respectively described in details below.

In S201, each collection time point corresponds to one timestamp, and the timestamp generally is a character sequence used for uniquely identifying a certain time. A timestamp offset may exist when the vehicle-mounted sensor collects the vehicle driving parameter information with respect to the integrated navigation device due to various reasons, for example, there is a delay when vehicle-mounted sensor collects the vehicle driving parameter information, or there is a delay when the integrated navigation device collects the vehicle driving parameter information, or there are delays when the vehicle-mounted sensor and the integrated navigation device collect the vehicle driving parameter information, and the delays are different from each other. In this case, if the calibration parameter information is directly determined according to the first vehicle driving parameter information and the second vehicle driving parameter information with the same timestamp, the accuracy of the calibration parameter information may be affected.

Therefore, in order to improve the accuracy of the calibration parameter information, the embodiments of the disclosure provide a scheme of first determining the timestamp offset value of the vehicle-mounted sensor with respect to the integrated navigation device before determining the calibration parameter information of the vehicle-mounted sensor, i.e., determining whether the collection time point for collecting the vehicle driving parameter information by the vehicle-mounted sensor with respect to the collection time point for collecting the vehicle driving parameter information by the integrated navigation device is delayed or advanced by a set time length.

In S202, after the timestamp offset value of the vehicle-mounted sensor with respect to the integrated navigation device is determined, the mapping relationship between the plurality of first collection time points for collecting the first vehicle driving parameter information and the plurality of second collection time points for collecting the second vehicle driving parameter information may be determined. Herein, the difference between the first collection time point and the second collection time point with the mapping relationship is equal to the timestamp offset value.

For example, table 1 below shows the first vehicle driving parameter values collected at six first collection time points when the vehicle-mounted sensor started working from eight o'clock on Aug. 8, 2019, and the second vehicle driving parameter values collected at six second collection time points when the integrated navigation device started working from eight o'clock on Aug. 8, 2019.

TABLE 1

| Vehicle-mounted sensor | | | Integrated navigation device | | |
|---|---|---|---|---|---|
| | | First | Identifier of | | Second |
| Identifier | | vehicle | second | | vehicle |
| of first | First | driving | collection | Second | driving |
| collection | collection | parameter | time point | collection | parameter |
| time point | time point | value | identifier | time point | value |
| A | 08:00:01 | L1 | A1 | 08:00:01 | M1 |
| B | 08:00:02 | L2 | B1 | 08:00:02 | M2 |
| C | 08:00:03 | L3 | C1 | 08:00:03 | M3 |
| D | 08:00:04 | L4 | D1 | 08:00:04 | M4 |
| E | 08:00:05 | L5 | E1 | 08:00:05 | M5 |
| F | 08:00:06 | L6 | F1 | 08:00:06 | M6 |

A timestamp representing a collection time point is in the format of a character string. In order to facilitate explanation, a date format is used to represent a specific time point. In addition, in order to facilitate description, letters are used to identify the time points. During the actual implementation, it is not needed to introduce the collection time point identifiers.

If it is determined that the timestamp offset value of the vehicle-mounted sensor with respect to the integrated navigation device is delayed by one second, the first collection time point of the vehicle-mounted sensor and the second collection time point of the integrated navigation device are not mapped according to the same timestamp, i.e., A does not correspond to A1, B does not correspond to B1, C does not correspond to C1, D does not correspond to D1, E does not correspond to E1, and F does not correspond to F1, but mapped according to the timestamp offset value, i.e., the difference value between the first collection time point and the second collection time point having the mapping relationship is equal to the timestamp offset value. Therefore, the mapping relationship between the first collection time points and the second collection time points in Table 1 is that A corresponds to B1, B corresponds to C1, C corresponds to D1, D corresponds to E1, and E corresponds to F1. If it is determined that the timestamp offset value of the vehicle-mounted sensor with respect to the integrated navigation device is advanced by one second, the mapping relationship between the first collection time points and the second collection time points in Table 1 is that B corresponds to A1, C corresponds to B1, D corresponds to C1, E corresponds to D1, and F corresponds to E1. The mapping relationship is only a mapping relationship between the plurality of first collection time points and the plurality of second collection time points exemplarily listed, and a mapping relationship between all the first collection time points and all the second collection time points are not provided.

After the mapping relationship between the plurality of first collection time points for collecting the first vehicle driving parameter information and the plurality of second collection time points for collecting the second vehicle driving parameter information is determined, the calibration parameter information of the vehicle-mounted sensor may be further determined according to the mapping relationship, the first vehicle driving parameter information collected by the vehicle-mounted sensor, and the accurate second vehicle driving parameter information collected by the integrated navigation device.

The embodiments of the disclosure provides a scheme of first determining the timestamp offset value of the vehicle-mounted sensor with respect to the integrated navigation device before determining the calibration parameter information of the vehicle-mounted sensor through the first vehicle driving parameter values of the plurality of first collection time points in the first vehicle driving parameter information and the second vehicle driving parameter values of the plurality of second collection time points in the second vehicle driving parameter information, then determining, according to the timestamp offset value, the mapping relationship between the plurality of first collection time points for collecting the first vehicle driving parameter information and the plurality of second collection time points for collecting the second vehicle driving parameter information, and determining the calibration parameter information of the vehicle-mounted sensor according to the determined mapping relationship. Therefore, the error caused by the timestamp misalignment can be avoided, thereby improving the accuracy of the calibration parameter information.

It is mentioned above that before the calibration parameter information is determined, it is needed to first determine the timestamp offset value of the vehicle-mounted sensor with respect to the integrated navigation device. The process of determining the timestamp offset value of the vehicle-mounted sensor with respect to the integrated navigation device may include presetting a plurality of timestamp offset values, then determining difference information between the first vehicle driving parameter information and the second vehicle driving parameter information at each timestamp offset value, and according to the difference information corresponding to each timestamp offset value, determining the timestamp offset value of the vehicle-mounted sensor with respect to the integrated navigation device.

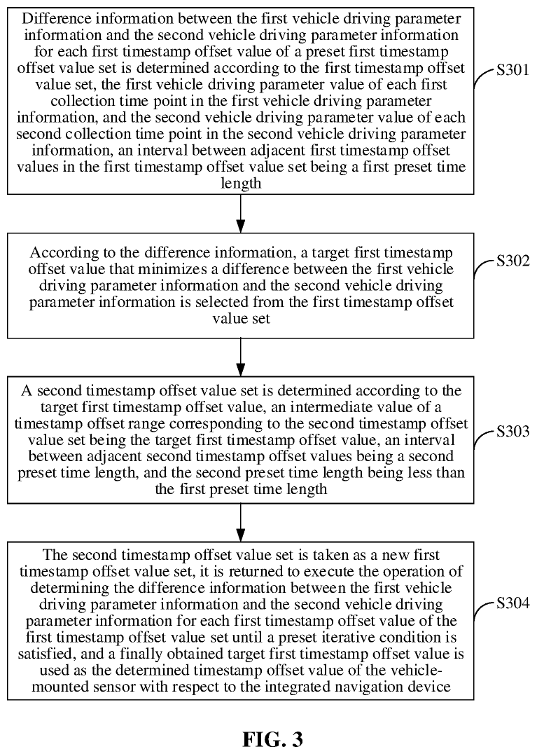

During the above process, in S201, the implementation of determining the timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information may include the following operations in S301 to S304, as shown in FIG. 3.

In S301, the difference information between the first vehicle driving parameter information and the second vehicle driving parameter information at each first timestamp offset value of a preset first timestamp offset value set is determined according to the first timestamp offset value set, the first vehicle driving parameter value of each first collection time point in the first vehicle driving parameter information, and the second vehicle driving parameter value of each second collection time point in the second vehicle driving parameter information. An interval between adjacent first timestamp offset values in the first timestamp offset value set is a first preset time length.

In S302, according to the difference information, a target first timestamp offset value that minimizes a difference between the first vehicle driving parameter information and the second vehicle driving parameter information is selected from the first timestamp offset value set.

In S303, a second timestamp offset value set is determined according to the target first timestamp offset value. An intermediate value of a timestamp offset range corresponding to the second timestamp offset value set is the target first timestamp offset value, an interval between adjacent second timestamp offset values is a second preset time length, and the second preset time length is less than the first preset time length.

In S304, the second timestamp offset value set is taken as a new first timestamp offset value set, it is returned to execute the operation of determining the difference information between the first vehicle driving parameter information and the second vehicle driving parameter information at each first timestamp offset value of the first timestamp offset value set until a preset iterative condition is satisfied, and a finally obtained target first timestamp offset value is used as the determined timestamp offset value of the vehicle-mounted sensor with respect to the integrated navigation device.

The above operations in S301 to S304 are respectively described in details below.

In S301, the first timestamp offset value set may include a plurality of first timestamp offset values. Before the first timestamp offset value set is set, a value range and the number of values (or a value interval) of the first timestamp offset value set may be set firstly, for example, a maximum first timestamp offset value in the first timestamp offset value set is set to be t₅, and a minimum first timestamp offset value is set to be 4, i.e., a range of the first timestamp offset value set is from t₁ to t₅. Then, a time interval between adjacent two first timestamp offset values, i.e., an iterative time interval when determining the difference information, is determined, for example, the time interval between adjacent two first timestamp offset values may be determined in an equal difference interpolation manner, so as to obtain the remaining first timestamp offset values. For example, between t₁ and t₅, three first timestamp offset values are obtained in the equal difference interpolation manner, i.e., the first timestamp offset values t₁, t₂, t₃, t₄, and t₅ included in the first timestamp offset value set may be obtained, and the time interval between every two adjacent first timestamp offset values is equal and is the first preset time length.

In some embodiments, each first timestamp offset value may be used to represent a delay time value of the vehicle-mounted sensor with respect to the integrated navigation device. For example, t=1 s, it is indicated that the vehicle-mounted sensor is delayed by one second at each collection time point with respect to the integrated navigation device; t=−1 s, it is indicated that the delay time value of the vehicle-mounted sensor with respect to the integrated navigation device is −1 s, i.e., it is indicated that the vehicle-mounted sensor is advanced by one second at each collection time point with respect to the integrated navigation device.

The difference information between the first vehicle driving parameter information and the second vehicle driving parameter information is respectively determined according to the preset first timestamp offset values.

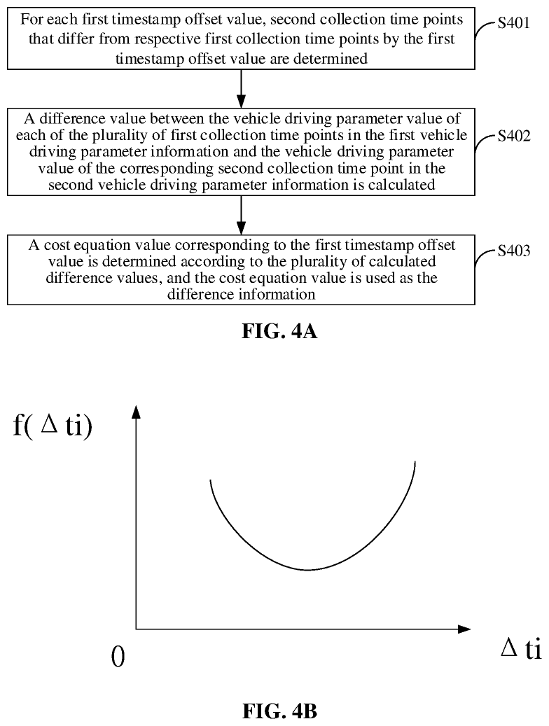

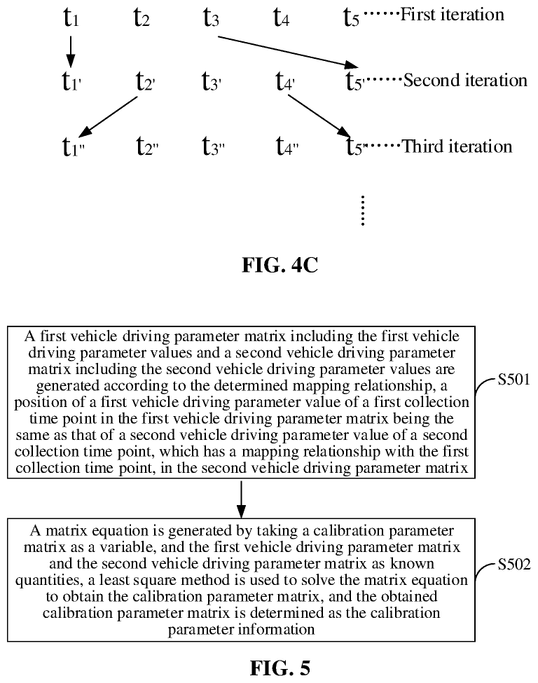

In some embodiments, as shown in FIG. 4A, the implementation of determining the difference information between the first vehicle driving parameter information and the second vehicle driving parameter information at each first timestamp offset value of the first timestamp offset value set includes the following operations S401 to S403.

In S401, for each first timestamp offset value, second collection time points that differ from respective first collection time points by the first timestamp offset value are determined.

For example, when the first timestamp offset value set includes 5 first timestamp offset values t₁˜t₅, for the first timestamp offset value t₁, the second collection time points that differ from each first collection time point in the first vehicle driving parameter information by t₁ are determined. For example, t₁=1s (the vehicle-mounted sensor is delayed by one second at each collection time point with respect to the integrated navigation device), it is indicated that a corresponding time of a timestamp of each determined second collection time point differs from a corresponding moment of the timestamp of each first collection time point by one second. Because the vehicle-mounted sensor is delayed with respect to the integrated navigation device, the corresponding moment of the timestamp of the determined second collection time point should be increased by one second with respect to the corresponding moment of the timestamp of the first collection time point. Taking Table 1 as an example, the second collection time points that respectively correspond to the first collection time points A to E are B1 to F1.

In S402, a difference value between the vehicle driving parameter value of each of the plurality of first collection time points in the first vehicle driving parameter information and the vehicle driving parameter value of the corresponding second collection time point in the second vehicle driving parameter information is calculated.

The second collection time points that respectively differ from the plurality of first collection time points by the first timestamp offset value are determined according to a manner in S401. That is, the second collection time points that respectively correspond to the plurality of first collection time points are determined, and then the difference value between the first vehicle driving parameter value of each of the plurality of first collection time points and the second vehicle driving parameter value of the corresponding second collection time point is calculated, so as to obtain a plurality of difference values. The vehicle driving parameter value may be the linear velocity value or the angular velocity value of the vehicle, and the plurality of corresponding difference values represent a plurality of linear velocity difference values or a plurality of angular velocity difference values.

In S403, a cost equation value corresponding to the first timestamp offset value is determined according to the plurality of calculated difference values, and the cost equation value is used as the difference information.

After the difference value between the first vehicle driving parameter value of each first collection time point and the second vehicle driving parameter value of the corresponding second collection time point is obtained, the cost equation value corresponding to the first timestamp offset value may be obtained by introducing a cost equation, such as the following formula (1), and the cost equation value is used as the difference information.

$$f ( Δ {t}_{1} ) = \frac{1}{N} {( {\sum }_{k - 1}^{N} {( {x}_{( k ) n v t} - {x}_{( k ) c a n} )}^{2} )}^{1 / 2} \qquad ( 1 )$$

In the formula, ƒ(Δtᵢ) represents a cost equation value corresponding to an ith first timestamp offset value in the first timestamp offset value set, N represents the number of first collection time points, k represents a kth first collection time point, and the range of k is from 1 to N, x₍ₖ₎ₙᵥₜ represents the second vehicle driving parameter value of the kth second collection time point, and x_{(k)can} represents the first vehicle driving parameter value of the kth first collection time point.

In some embodiments, the vehicle driving parameter values x_{(k)can} and x₍ₖ₎ₙᵥₜ may both be linear velocity values, and may also both be angular velocity values. Considering that the angular velocity value has higher sensitivity than the linear velocity value when the timestamp offset value is determined, the embodiments of the disclosure preferentially use the angular velocity values to determine the timestamp offset value of the vehicle-mounted sensor with respect to the integrated navigation device.

Correspondingly, when the timestamp offset value of the vehicle-mounted sensor with respect to the integrated navigation device is determined through the angular velocity value, the following formula (2) is used.

$$f ( Δ {t}_{i} ) = \frac{1}{N} {( {\sum }_{k - 1}^{N} {( {ω}_{{( k )}_{nvt}} - {ω}_{( k ) c a n} )}^{2} )}^{1 / 2} \qquad ( 2 )$$

In the formula, ω₍ₖ₎ₙᵥₜ represents an angular velocity value of a kth second collection time point, and ω_{(k)can} represents an angular velocity value of a kth first collection time point.

It is to be noted that the vehicle driving parameters are simultaneously collected when the vehicle-mounted sensor and the integrated navigation device are tested. The first timestamp offset value is defined within the first timestamp offset value set, which may ensure that the cost equation is a convex function. Referring to FIG. 4B, the function curve of ƒ(Δtᵢ) is shown in FIG. 4B.

The timestamp offset value that minimizes the cost equation value in the limited loop iteration is obtained by introducing the cost equation. The smaller cost equation value represents that the timestamp alignment is better.

In S302, the difference information between the first vehicle driving parameter information at each first timestamp offset value of the first timestamp offset value set and the second vehicle driving parameter information may be determined according to a process of the operations in S401 to S403, and then the first timestamp offset value with minimum difference information is selected as the target first timestamp offset value.

As mentioned above, the difference information may be represented through the cost equation value. Then, when the minimum difference information is determined, the minimum difference information may be represented through a minimum cost equation value. For example, for the case that the first timestamp offset value set is t₁˜t₅, it may be determined that the cost equation values for five first timestamp offset values respectively are ƒ(Δt₁)˜ƒ(Δt₅), and the minimum cost equation value is selected from the five cost equation values. If ƒ(Δt₂) is minimum, the target first timestamp offset value is t₂.

In S303, after the target first timestamp offset value is determined, the value range and the value interval of the first timestamp offset value set used for next iteration may be reduced according to the target first timestamp offset value, so as to improve the accuracy of a finally determined timestamp offset value of the vehicle-mounted sensor with respect to the integrated navigation device.

The manner of determining a second timestamp offset value set may include taking two first timestamp offset values adjacent to the target first timestamp offset value as the range of an updated second timestamp offset value set, and then determining the remaining second timestamp offset values in the equal difference interpolation manner.

For example, for the case that the first timestamp offset value set is t₁˜t₅, when the target first timestamp offset value is t₂, t₁ and t₃ adjacent to t₂ may be respectively used as a minimum timestamp offset value and a maximum timestamp offset value of the second timestamp offset value set, and then the remaining second timestamp offset values between t₁ and t₃ are reset, such as setting three second timestamp offset values in the equal difference interpolation manner Therefore, the second timestamp offset value set still includes five second timestamp offset values.

Alternatively, the manner of determining the second timestamp offset value set may also include another manner, such as taking the target first timestamp offset value of the last iteration as an intermediate value, respectively obtaining values from the left and right sides of the intermediate value according to a time interval less than the time interval used in the last iteration, obtaining a preset number of values as the second timestamp offset values, and entering the next iteration.

In S304, after the second timestamp offset value set is obtained, the second timestamp offset value set is taken as the new first timestamp offset value set, then it is returned to the operation in S301 for restarting execution, i.e., determining the difference information between the first vehicle driving parameter information and the second vehicle driving parameter information at each first timestamp offset value in the new first timestamp offset value set, and performing the loop until the preset iterative condition is satisfied. The finally determined target first timestamp offset value is used as the determined timestamp offset value of the vehicle-mounted sensor with respect to the integrated navigation device.

Herein, the timestamp offset value within a preset accuracy range is obtained by gradually reducing the range of the new first timestamp offset value set, and satisfying the preset iterative condition may mean reaching a preset number of iterations, or the cost equation value corresponding to the target first timestamp offset value is less than a set threshold, etc.

Exemplarily, referring to FIG. 4C, the first timestamp offset value set is t₁−t₅, it is determined from f(t₁)−f(t₅) that f(t₂) is minimum, and then t₂ is used as the target first timestamp offset value obtained through the first iteration. In such case, t₁ and t₃ may be respectively used as the maximum value and the minimum value of the new first timestamp offset value set, so as to construct the new first timestamp offset value set: t_{1′}-t_{5′}, wherein t₁ is t_{1′}, t₃ is t_{5′}, and t_{2′}−t₄ are new first timestamp offset values that are set in the equal difference interpolation manner. If f(t_{3′}) is minimum in f(t_{1′})−f(t_{5′}), f(t_{3′}) is used as a new target first timestamp offset value obtained through the second iteration. In such case, t_{2′} and t_{4′} may be continuously used as the maximum value and the minimum value of a new first timestamp set, so as to construct the new first timestamp offset value set, a third iteration is performed, and so on, until the preset iterative condition is satisfied.

Through the above loop iteration process, the timestamp offset value with a small error and high accuracy can be obtained, thereby improving the accuracy of the determined calibration parameter information.

After the timestamp offset value of the vehicle-mounted sensor with respect to the integrated navigation device is obtained, the mapping relationship between the plurality of first collection time points for collecting the first vehicle driving parameter information and the plurality of second collection time points for collecting the second vehicle driving parameter information may be accurately determined according to the timestamp offset value, and then the calibration parameter information of the vehicle-mounted sensor may be determined according to the mapping relationship, the first vehicle driving parameter values of the plurality of first collection time points in the first vehicle driving parameter information, and the second vehicle driving parameter values of the plurality of second collection time points in the second vehicle driving parameter information. As shown in FIG. 5, the following operations in S501 and S502 are included.

In S501, a first vehicle driving parameter matrix including the first vehicle driving parameter values and a second vehicle driving parameter matrix including the second vehicle driving parameter values are generated according to the determined mapping relationship. A position of a first vehicle driving parameter value of a first collection time point in the first vehicle driving parameter matrix is the same as that of a second vehicle driving parameter value of a second collection time point, which has a mapping relationship with the first collection time point, in the second vehicle driving parameter matrix.

The first collection time point may be any one of the plurality of first collection time points.

In S502, a matrix equation is generated by taking a calibration parameter matrix as a variable, and the first vehicle driving parameter matrix and the second vehicle driving parameter matrix as known quantities, a least square method is used to solve the matrix equation to obtain the calibration parameter matrix, and the obtained calibration parameter matrix is determined as the calibration parameter information.

Because the first vehicle driving parameter information includes the first vehicle driving parameter values collected at the plurality of first collection time points, and the second vehicle driving parameter information also includes the second vehicle driving parameters collected at the plurality of second collection time points, the calibration parameter information may be determined according to the plurality of first vehicle driving parameter values in the first vehicle driving parameter information and the plurality of second vehicle driving parameter values in the second vehicle driving parameter information.

In some embodiments, through the determined mapping relationship between the plurality of first collection time points for collecting the first vehicle driving parameter information and the plurality of second collection time points for collecting the second vehicle driving parameter information, the first vehicle driving parameter values of the first collection time points may correspond to the second vehicle driving parameter values of the second collection time points having the mapping relationship, so as to obtain the first vehicle driving parameter matrix and the second vehicle driving parameter matrix. The position of the first vehicle driving parameter value of the first collection time point in the first vehicle driving parameter matrix is the same as that of the second vehicle driving parameter value of the second collection time point, which has the mapping relationship with the first collection time point, in the second vehicle driving parameter matrix. Then, the calibration parameter matrix consisting of unknown calibration parameter information that needs to be determined is taken as the variable, and the first vehicle driving parameter matrix and the second vehicle driving parameter matrix are taken as the known quantities, so as to generate the matrix equation. The matrix equation is solved according to the least square method, i.e., the calibration parameter information may be determined.

In the specific implementation, before the matrix equation is generated, a preset vehicle driving parameter information output model formula (3) is first introduced.

xₒ=a*x₈+b (3)

In the formula, xₒ represents a first vehicle driving parameter value outputted by the vehicle-mounted sensor at one first collection time point, x_{g} represents a second vehicle driving parameter value outputted by the integrated navigation device at the second collection time point having the mapping relationship with the first collection time point, a represents a scale in the calibration parameter information, and b represents an offset in the calibration parameter information.

The matrix equation is constructed according to the formula (3), so as to obtain the following formula (4).

Xₒ=X_{g}×C_{X} (4)

In the formula, Xₒ represents the first vehicle driving parameter matrix consisting of the first vehicle driving parameter values outputted by the vehicle-mounted sensor, X_{g} represents the second vehicle driving parameter matrix consisting of the second vehicle driving parameter values outputted by the integrated navigation device, and C_{X} represents the calibration parameter matrix of the vehicle-mounted sensor.

When the first vehicle driving parameter matrix and the second vehicle driving parameter matrix are known quantities, as long as the number of the first vehicle driving parameter values in the first vehicle driving parameter information and the number of the second vehicle driving parameter values in the second vehicle driving parameter information are sufficient, an accurate calibration parameter matrix can be determined, i.e., the calibration parameter information of the vehicle-mounted sensor is obtained.

The embodiments of the disclosure construct the matrix equation and use the least square method to obtain an optimal solution of the calibration parameter matrix, thereby obtaining the calibration parameter information with a high accuracy.

The type of the vehicle driving parameter information in the embodiments of the disclosure is not limited to one type. Different types of vehicle driving parameter information may be uniformly calibrated according to the calibration method provided by the embodiments of the disclosure.

In some embodiments, in S502, the implementation of generating the matrix equation by taking the calibration parameter matrix as the variable, and the first vehicle driving parameter matrix and the second vehicle driving parameter matrix as known quantities, solving the matrix equation by using the least square method may include the following several cases.

(1) A linear velocity calibration parameter matrix is taken as a variable, and a first linear velocity matrix in the first vehicle driving parameter information and a second linear velocity matrix in the second vehicle driving parameter information are taken as known quantities to generate the matrix equation, and the least square method is used to solve the matrix equation to obtain the linear velocity calibration parameter matrix.

(2) An angular velocity calibration parameter matrix is taken as a variable, and a first angular velocity matrix in the first vehicle driving parameter information and a second angular velocity matrix in the second vehicle driving parameter information are taken as known quantities to generate the matrix equation, and the least square method is used to solve the matrix equation to obtain the angular velocity calibration parameter matrix.

(3) The linear velocity calibration parameter matrix is taken as the variable, and the first linear velocity matrix in the first vehicle driving parameter information and the second linear velocity matrix in the second vehicle driving parameter information are taken as the known quantities to generate the matrix equation, and the least square method is used to obtain the linear velocity calibration parameter matrix, and the angular velocity calibration parameter matrix is taken as the variable, and the first angular velocity matrix in the first vehicle driving parameter information and the second angular velocity matrix in the second vehicle driving parameter information are taken as the known quantities to generate the matrix equation, and the least square method is used to solve the matrix equation to obtain the angular velocity calibration parameter matrix.

For the case (1), the first vehicle driving parameter information includes first vehicle linear velocity values collected by the vehicle-mounted sensor at the plurality of first collection time points, and the second vehicle driving parameter information includes second vehicle linear velocity values collected by the integrated navigation device at the plurality of second collection time points. In this case, the vehicle driving parameter information output model is a vehicle linear velocity value output model, as shown in the following formula (5).

vₒ=a*v_{g}+b (5)

In the formula, vₒ represents a first linear velocity value outputted by the vehicle-mounted sensor at any one first collection time point, v_{g} represents a second linear velocity value outputted by the integrated navigation device at the second collection time point having the mapping relationship with the first collection time point, a represents a scale in the calibration parameter information, and b represents the offset in the calibration parameter information.

Correspondingly, the matrix equation is constructed according to the formula (5), to obtain the following formula (6).

Vₒ=V_{g}×C_{V} (6)

In the formula, Vₒ represents a matrix consisting of first linear velocity values outputted by the vehicle-mounted sensor at the plurality of first collection time points, V_{g} represents a matrix consisting of second linear velocity values outputted by the integrated navigation device at the second collection time points corresponding to the plurality of first collection time points, and C_{V} represents the calibration parameter matrix of the vehicle-mounted sensor about the linear velocity values.

For example, linear velocity values outputted by the vehicle-mounted sensor at three first collection time points are respectively recorded as vₒ₁, vₒ₂, and vₒ₃, linear velocity values outputted by the integrated navigation device at three second collection time points having the mapping relationships with the three first collection time points are respectively recorded v_{g1}, v_{g2}, and v_{g3}, and C_{V} includes a and b, then the generated matrix equation may be represented by the following formula (7).

$$[ \begin{matrix}{v}_{o 1} \\ {v}_{o 2} \\ {v}_{o 3}\end{matrix} ] = [ \begin{matrix}{v}_{g 1} & 1 \\ {v}_{g 2} & 1 \\ {v}_{g 3} & 1\end{matrix} ] \times [ \begin{matrix}a \\ b\end{matrix} ] \qquad ( 7 )$$

In the formula (7), vₒ₁, vₒ₂, and vₒ₃, as well as v_{g1}, v_{g2}, and v_{g3} are known quantities, and a and b are unknown quantities. The calibration parameter information a and b may be solved according to the least square method, i.e., the calibration parameter matrix of the vehicle-mounted sensor about the linear velocity values may be determined.

For the case (2), the first vehicle driving parameter information includes first vehicle angular velocity values collected by the vehicle-mounted sensor at the plurality of first collection time points, and the second vehicle driving parameter information includes second vehicle angular velocity values collected by the integrated navigation device at the plurality of second collection time points. In this case, the vehicle driving parameter information output model is a vehicle angular velocity value output model, as shown in the following formula (8).

wₒ=a*w_{g}+b (8)

In the formula, wₒ represents a first angular velocity value outputted by the vehicle-mounted sensor at any one first collection time point, w_{g} represents a second angular velocity value outputted by the integrated navigation device at the second collection time point having the mapping relationship with the first collection time point, a represents a scale in the calibration parameter information, and b represents an offset in the calibration parameter information.

Correspondingly, the matrix equation is constructed according to the formula (8), to obtain the following formula (9).

Wₒ=W_{g}×C_{W} (9)

In the formula, Wₒ represents a matrix consisting of first angular velocity values outputted by the vehicle-mounted sensor at the plurality of first collection time points, W_{g} represents a matrix consisting of second angular velocity values outputted by the integrated navigation device at the second collection time points corresponding to the plurality of first collection time points, and C_{W} represents the calibration parameter matrix of the vehicle-mounted sensor about the angular velocity values.

For example, angular velocity values outputted by the vehicle-mounted sensor at three first collection time points are respectively recorded as wₒ₁, wₒ₂, and wₒ₃, angular velocity values outputted by the integrated navigation device at three second collection time points having the mapping relationships with the three first collection time points are respectively recorded w_{g1}, w_{g2}, and w_{g3}, and C_{W} includes a and b, then the generated matrix equation may be represented by the following formula (10).

$$[ \begin{matrix}{w}_{o 1} \\ {w}_{o 2} \\ {w}_{o 3}\end{matrix} ] = [ \begin{matrix}{w}_{g 1} & 1 \\ {w}_{g 2} & 1 \\ {w}_{g 3} & 1\end{matrix} ] \times [ \begin{matrix}a \\ b\end{matrix} ] \qquad ( 10 )$$

In the formula (10), wₒ₁, wₒ₂, and wₒ₃, as well as w_{g1}, w_{g2}, and w_{g3} are known quantities, and a and b are unknown quantities. The calibration parameter information a and b may be solved according to the least square method, i.e., the calibration parameter matrix of the vehicle-mounted sensor about the angular velocity values may be determined.

For the case (3), the vehicle-mounted sensor integrated with an angular velocity sensor and a linear velocity sensor may simultaneously collect the linear velocity values and the angular velocity values during driving of the target vehicle, and the integrated navigation device may also simultaneously collect the linear velocity values and the angular velocity values during driving of the target vehicle. Therefore, the calibration parameter information of the vehicle-mounted sensor about the linear velocity values and the calibration parameter information of the vehicle-mounted sensor about the angular velocity values can be simultaneously determined, i.e., different types of data are calibrated once.

The embodiments of the disclosure may determine the calibration parameter information of the vehicle-mounted sensor about the linear velocity values, and may also determine the calibration parameter information of the vehicle-mounted sensor about the angular velocity values. In addition, the calibration parameter information of the vehicle-mounted sensor about the linear velocity values and the calibration parameter information of the vehicle-mounted sensor about the angular velocity values may be further simultaneously determined, i.e., different types of sensor parameters are calibrated once.

By using the vehicle driving parameter information outputted by the integrated navigation device to calibrate the vehicle driving parameter information of the vehicle-mounted sensor, the embodiments of the disclosure have no special requirement for a calibration place, and do not require the vehicle to travel according to a specific travel trajectory, thereby simplifying the calibration process of the vehicle-mounted sensor and improving the calibration efficiency. In addition, it is not required to consider an error caused by mismatch of the travel trajectory of the vehicle and a set trajectory, thereby further improving the accuracy of the calibration result.

Those skilled in the art may understand that, in the above methods of the specific implementations, the writing order of the operations does not imply a strict execution order and constitute any limitation to the implementation process, and the execution order of each operation should be determined by its functions and a possible internal logic thereof.

Based on the same technical concept, the embodiments of the disclosure further provide a calibration apparatus corresponding to the calibration method. The principles of the apparatus to solve the problem in the embodiments of the disclosure are similar to those of the calibration method in the embodiments of the disclosure, and thus the implementation of the apparatus may make reference to the implementation of the method. Details are not described herein again.

As shown in FIG. 6, the embodiments of the disclosure provide a calibration apparatus 600, including an obtaining portion 601 and a determining portion 602.

The obtaining portion 601 is configured to obtain first vehicle driving parameter information outputted by a vehicle-mounted sensor and second vehicle driving parameter information outputted by an integrated navigation device during driving of a target vehicle. The first vehicle driving parameter information and the second vehicle driving parameter information respectively include vehicle driving parameter values collected at different collection time points.

The determining portion 602 is configured to determine calibration parameter information of the vehicle-mounted sensor according to first vehicle driving parameter values of a plurality of first collection time points in the first vehicle driving parameter information, and second vehicle driving parameter values of a plurality of second collection time points in the second vehicle driving parameter information.

In one possible implementation, the determining portion 602 is further configured to:

determine a timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information;

determine a mapping relationship between the plurality of first collection time points for collecting the first vehicle driving parameter information and the plurality of second collection time points for collecting the second vehicle driving parameter information according to the determined timestamp offset value, wherein a difference value between the first collection time point and the second collection time point having a mapping relationship with the first collection time point is equal to the timestamp offset value; and

determine the calibration parameter information of the vehicle-mounted sensor according to the determined mapping relationship, the first vehicle driving parameter values of the plurality of first collection time points in the first vehicle driving parameter information, and the second vehicle driving parameter values of the plurality of second collection time points in the second vehicle driving parameter information.

In one possible implementation, the determining portion 602 is further configured to:

generate, according to the determined mapping relationship, a first vehicle driving parameter matrix including the first vehicle driving parameter values and a second vehicle driving parameter matrix including the second vehicle driving parameter values, a position of a first vehicle driving parameter value of a first collection time point in the first vehicle driving parameter matrix being the same as that of a second vehicle driving parameter value of a second collection time point, which has a mapping relationship with the first collection time point, in the second vehicle driving parameter matrix; and

generate a matrix equation by taking a calibration parameter matrix as a variable, and the first vehicle driving parameter matrix and the second vehicle driving parameter matrix as known quantities, solve the matrix equation by using a least square method to obtain the calibration parameter matrix, and determine the obtained calibration parameter matrix as the calibration parameter information.

In one possible implementation, the determining portion 602 is further configured to generate the matrix equation by taking a linear velocity calibration parameter matrix as a variable, and a first linear velocity matrix in the first vehicle driving parameter information and a second linear velocity matrix in the second vehicle driving parameter information as known quantities, and solve the matrix equation by using the least square method to obtain the linear velocity calibration parameter matrix.

In one possible implementation, the determining portion 602 is further configured to generate the matrix equation by taking an angular velocity calibration parameter matrix as a variable, and a first angular velocity matrix in the first vehicle driving parameter information and a second angular velocity matrix in the second vehicle driving parameter information as known quantities, and solve the matrix equation by using the least square method to obtain the angular velocity calibration parameter matrix.

In one possible implementation, the determining portion 602 is further configured to:

determine, according to a preset first timestamp offset value set, the first vehicle driving parameter value of each first collection time point in the first vehicle driving parameter information, and the second vehicle driving parameter value of each second collection time point in the second vehicle driving parameter information, difference information between the first vehicle driving parameter information and the second vehicle driving parameter information at each first timestamp offset value in the first timestamp offset value set, an interval between adjacent first timestamp offset values in the first timestamp offset value set being a first preset time length;

select a target first timestamp offset value that minimizes a difference between the first vehicle driving parameter information and the second vehicle driving parameter information from the first timestamp offset value set according to the difference information;

determine a second timestamp offset value set according to the target first timestamp offset value, an intermediate value of a timestamp offset range corresponding to the second timestamp offset value set being the target first timestamp offset value, an interval between adjacent second timestamp offset values being a second preset time length, and the second preset time length being less than the first preset time length; and

take the second timestamp offset value set as a new first timestamp offset value set, return to execute the operation of determining the difference information between the first vehicle driving parameter information and the second vehicle driving parameter information at each first timestamp offset value in the first timestamp offset value set until a preset iterative condition is satisfied, and use a finally obtained target first timestamp offset value as the determined timestamp offset value of the vehicle-mounted sensor with respect to the integrated navigation device.

In one possible implementation, the determining portion 602 is further configured to:

for each first timestamp offset value, determine second collection time points that differ from respective first collection time points by the first timestamp offset value;

calculate a difference value between the vehicle driving parameter value of each of the plurality of first collection time points in the first vehicle driving parameter information and the vehicle driving parameter value of the corresponding second collection time point in the second vehicle driving parameter information; and

determine, according to the calculated difference values, a cost equation value corresponding to the first timestamp offset value, and determine the cost equation value as the difference information.

In the embodiments of the disclosure and other embodiments, “portion” may refer to a portion of a circuit, a portion of a processor, a portion of a program or software, etc., of course, may also refer to a unit, and may also be a module or non-modular.

In some embodiments, the apparatus provided by the embodiments of the disclosure has the functions or includes the modules for implementing the method described in the foregoing method embodiments, the specific implementation of which may make reference to the description in the method embodiments. For the purpose of brevity, details are not described herein again.

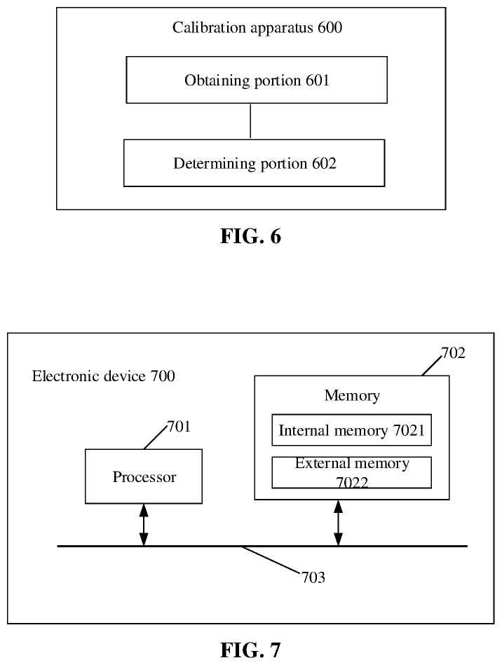

The embodiments of the disclosure further provide an electronic device 700. FIG. 7 is a schematic structural diagram of an electronic device provided by an embodiment of the disclosure, including a processor 701, a memory 702, and a bus 703. The memory 702 is configured to store an executable instruction, and includes an internal memory 7021 and an external memory 7022. The internal memory 7021 herein is also referred to as an internal memory, and is configured to temporarily store processing data in the processor 701 and data exchanged with the external memory 7022 such as a hard disk. The processor 701 exchanges data with the external memory 7022 through the internal memory 7021. When the electronic device 700 runs, the processor 701 communicates with the memory 702 through the bus 703, so that the processor 701 executes the following instructions: obtaining first vehicle driving parameter information outputted by a vehicle-mounted sensor and second vehicle driving parameter information outputted by an integrated navigation device during driving of a target vehicle, the first vehicle driving parameter information and the second vehicle driving parameter information respectively including vehicle driving parameter values collected at different collection time points; and determining the calibration parameter information of the vehicle-mounted sensor according to the first vehicle driving parameter values of the plurality of first collection time points in the first vehicle driving parameter information, and the second vehicle driving parameter values of the plurality of second collection time points in the second vehicle driving parameter information.

The embodiments of the disclosure further provide a computer readable storage medium. The computer readable storage medium stores a computer program, and when the computer program is run by a processor, the operations of the calibration method in the foregoing method embodiments are implemented.

A computer program product for the calibration method provided by the embodiments of the disclosure includes a computer readable storage medium that stores a program code. An instruction included in the program code may be configured to implement the operations of the calibration method in the foregoing method embodiments. Reference may be made to the foregoing method embodiments, which are not elaborated herein.

Those skilled in the art can clearly understand that specific working processes of the system and device described above may refer to the corresponding processes in the method embodiments and will not be elaborated herein for convenient and brief description. It is to be understood that the disclosed system, device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and the parts displayed as units may or may not be physical units, may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being realized in form of software functional unit and sold or used as an independent product, the function may also be stored in a nonvolatile computer-readable storage medium executable by a processor. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the operations of the method in each embodiment of the disclosure. The abovementioned storage medium includes: various media capable of storing program codes such as a U disk, a mobile hard disk, a Read-Only Memory (ROM), a Random Access Memory (RAM), a floppy disk, and an optical disc.

Finally, it should be noted that, the above embodiments are only the specific implementation modes of the disclosure and intended to describing the technical solutions of the disclosure, not limit the scope of protection of the disclosure. Although the disclosure is described in detail with reference to the above embodiments, it is to be understood by those of ordinary skill in the art that any person skilled in the art may modify or easily conceive to change the technical solutions described in the above embodiments, or make equivalent replacements to part of the technical features within the technical scope disclosed by the disclosure. Such modifications, changes, or replacements do not make the essence of the corresponding technical solutions depart from the spirit and scope of the technical solutions of the embodiments of the disclosure, and should fall within the scope of protection of the disclosure. Therefore, the scope of protection of the disclosure shall be subject to the scope of protection of the claims.

### INDUSTRIAL APPLICABILITY

In the embodiments of the disclosure, the vehicle driving parameter information outputted by an integrated navigation device can be used to calibrate the vehicle driving parameter information of a vehicle-mounted sensor, and thus, the embodiments of the disclosure have no special requirement for a calibration place, and do not require a vehicle to travel according to a specific travel trajectory, thereby simplifying the calibration process of the vehicle-mounted sensor and improving calibration efficiency. In addition, it is not required to consider an error caused by the mismatch of the travel trajectory of the vehicle and a set trajectory, thereby further improving the accuracy of the calibration result.

1. A calibration method, comprising:
obtaining first vehicle driving parameter information outputted by a vehicle-mounted sensor and second vehicle driving parameter information outputted by an integrated navigation device during driving of a target vehicle; and
determining calibration parameter information of the vehicle-mounted sensor according to first vehicle driving parameter values of a plurality of first collection time points in the first vehicle driving parameter information and second vehicle driving parameter values of a plurality of second collection time points in the second vehicle driving parameter information.

2. The calibration method of claim 1, wherein determining the calibration parameter information of the vehicle-mounted sensor according to first vehicle driving parameter values of the plurality of first collection time points in the first vehicle driving parameter information and second vehicle driving parameter values of the plurality of second collection time points in the second vehicle driving parameter information comprises:
determining a timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information;
determining, according to the determined timestamp offset value, a mapping relationship between the plurality of first collection time points for collecting the first vehicle driving parameter information and the plurality of second collection time points for collecting the second vehicle driving parameter information; and
determining the calibration parameter information of the vehicle-mounted sensor according to the determined mapping relationship, the first vehicle driving parameter values of the plurality of first collection time points in the first vehicle driving parameter information, and the second vehicle driving parameter values of the plurality of second collection time points in the second vehicle driving parameter information.

3. The calibration method of claim 2, wherein determining the calibration parameter information of the vehicle-mounted sensor according to the determined mapping relationship, the first vehicle driving parameter values of the plurality of first collection time points in the first vehicle driving parameter information and the second vehicle driving parameter values of the plurality of second collection time points in the second vehicle driving parameter information comprises:
generating, according to the determined mapping relationship, a first vehicle driving parameter matrix comprising the first vehicle driving parameter values and a second vehicle driving parameter matrix comprising the second vehicle driving parameter values, wherein a position of a first vehicle driving parameter value of a first collection time point in the first vehicle driving parameter matrix is the same as that of a second vehicle driving parameter value of a second collection time point having a mapping relationship with the first collection time point in the second vehicle driving parameter matrix; and
generating a matrix equation by taking a calibration parameter matrix as a variable, and the first vehicle driving parameter matrix and the second vehicle driving parameter matrix as known quantities, solving the matrix equation by using a least square method to obtain the calibration parameter matrix, and determining the obtained calibration parameter matrix as the calibration parameter information.

4. The calibration method of claim 3, wherein generating the matrix equation by taking the calibration parameter matrix as a variable, and the first vehicle driving parameter matrix and the second vehicle driving parameter matrix as known quantities, solving the matrix equation by using the least square method to obtain the calibration parameter matrix comprises:
generating the matrix equation by taking a linear velocity calibration parameter matrix as a variable, and a first linear velocity matrix in the first vehicle driving parameter information and a second linear velocity matrix in the second vehicle driving parameter information as known quantities, and solving the matrix equation by using the least square method to obtain the linear velocity calibration parameter matrix.

5. The calibration method of claim 3, wherein generating the matrix equation by taking the calibration parameter matrix as a variable, and the first vehicle driving parameter matrix and the second vehicle driving parameter matrix as known quantities, solving the matrix equation by using the least square method to obtain the calibration parameter matrix comprises:
generating the matrix equation by taking an angular velocity calibration parameter matrix as a variable, and a first angular velocity matrix in the first vehicle driving parameter information and a second angular velocity matrix in the second vehicle driving parameter information as known quantities, and solving the matrix equation by using the least square method to obtain the angular velocity calibration parameter matrix.

6. The calibration method of claim 2, wherein determining the timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information comprises:
determining difference information between the first vehicle driving parameter information and the second vehicle driving parameter information at each first timestamp offset value of a preset first timestamp offset value set according to the first timestamp offset value set, the first vehicle driving parameter value of each first collection time point in the first vehicle driving parameter information, and the second vehicle driving parameter value of each second collection time point in the second vehicle driving parameter information, wherein an interval between adjacent first timestamp offset values in the first timestamp offset value set is a first preset time length;
selecting a target first timestamp offset value that minimizes a difference between the first vehicle driving parameter information and the second vehicle driving parameter information from the first timestamp offset value set according to the difference information;
determining a second timestamp offset value set according to the target first timestamp offset value, wherein an intermediate value of a timestamp offset range corresponding to the second timestamp offset value set is the target first timestamp offset value, an interval between adjacent second timestamp offset values is a second preset time length, and the second preset time length is less than the first preset time length; and
taking the second timestamp offset value set as a new first timestamp offset value set, returning to determine the difference information between the first vehicle driving parameter information and the second vehicle driving parameter information at each first timestamp offset value of the first timestamp offset value set until a preset iterative condition is satisfied, and using a finally obtained target first timestamp offset value as the determined timestamp offset value of the vehicle-mounted sensor with respect to the integrated navigation device.

7. The calibration method of claim 6, wherein determining the difference information between the first vehicle driving parameter information and the second vehicle driving parameter information at each first timestamp offset value of the first timestamp offset value set comprises:
for each first timestamp offset value, determining second collection time points that differ from respective first collection time points by the first timestamp offset value;
calculating a difference value between a vehicle driving parameter value of each of the plurality of first collection time points in the first vehicle driving parameter information and a vehicle driving parameter value of a corresponding second collection time point in the second vehicle driving parameter information; and
determining, according to the calculated difference values, a cost equation value corresponding to the first timestamp offset value, and determining the cost equation value as the difference information.

8. A calibration apparatus, comprising: a processor, and a non-transitory computer-readable storage medium for storing instructions executable by the processor;
wherein the processor is configured to:
obtain first vehicle driving parameter information outputted by a vehicle-mounted sensor and second vehicle driving parameter information outputted by an integrated navigation device during driving of a target vehicle; and
determine calibration parameter information of the vehicle-mounted sensor according to first vehicle driving parameter values of a plurality of first collection time points in the first vehicle driving parameter information and second vehicle driving parameter values of a plurality of second collection time points in the second vehicle driving parameter information.

9. The calibration apparatus of claim 8, wherein the processor is further configured to:
determine a timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information;
determine, according to the determined timestamp offset value, a mapping relationship between the plurality of first collection time points for collecting the first vehicle driving parameter information and the plurality of second collection time points for collecting the second vehicle driving parameter information; and
determine the calibration parameter information of the vehicle-mounted sensor according to the determined mapping relationship, the first vehicle driving parameter values of the plurality of first collection time points in the first vehicle driving parameter information, and the second vehicle driving parameter values of the plurality of second collection time points in the second vehicle driving parameter information.

10. The calibration apparatus of claim 9, wherein the processor is further configured to:
generate, according to the determined mapping relationship, a first vehicle driving parameter matrix comprising the first vehicle driving parameter values and a second vehicle driving parameter matrix comprising the second vehicle driving parameter values, wherein a position of a first vehicle driving parameter value of a first collection time point in the first vehicle driving parameter matrix is the same as that of a second vehicle driving parameter value of a second collection time point having a mapping relationship with the first collection time point in the second vehicle driving parameter matrix; and
generate a matrix equation by taking a calibration parameter matrix as a variable, and the first vehicle driving parameter matrix and the second vehicle driving parameter matrix as known quantities, solve the matrix equation by using a least square method to obtain the calibration parameter matrix, and determine the obtained calibration parameter matrix as the calibration parameter information.

11. The calibration apparatus of claim 10, wherein the processor is further configured to:
generate the matrix equation by taking a linear velocity calibration parameter matrix as a variable, and a first linear velocity matrix in the first vehicle driving parameter information and a second linear velocity matrix in the second vehicle driving parameter information as known quantities, and solve the matrix equation by using the least square method to obtain the linear velocity calibration parameter matrix.

12. The calibration apparatus of claim 10, wherein the processor is further configured to:
generate the matrix equation by taking an angular velocity calibration parameter matrix as a variable, and a first angular velocity matrix in the first vehicle driving parameter information and a second angular velocity matrix in the second vehicle driving parameter information as known quantities, and solve the matrix equation by using the least square method to obtain the angular velocity calibration parameter matrix.

13. The calibration apparatus of claim 9, wherein the processor is further configured to:
determine difference information between the first vehicle driving parameter information and the second vehicle driving parameter information at each first timestamp offset value of a preset first timestamp offset value set according to the first timestamp offset value set, the first vehicle driving parameter value of each first collection time point in the first vehicle driving parameter information, and the second vehicle driving parameter value of each second collection time point in the second vehicle driving parameter information, wherein an interval between adjacent first timestamp offset values in the first timestamp offset value set is a first preset time length;
select a target first timestamp offset value that minimizes a difference between the first vehicle driving parameter information and the second vehicle driving parameter information from the first timestamp offset value set according to the difference information;
determine a second timestamp offset value set according to the target first timestamp offset value, wherein an intermediate value of a timestamp offset range corresponding to the second timestamp offset value set is the target first timestamp offset value, an interval between adjacent second timestamp offset values is a second preset time length, and the second preset time length is less than the first preset time length; and
take the second timestamp offset value set as a new first timestamp offset value set, return to determine the difference information between the first vehicle driving parameter information and the second vehicle driving parameter information at each first timestamp offset value of the first timestamp offset value set until a preset iterative condition is satisfied, and use a finally obtained target first timestamp offset value as the determined timestamp offset value of the vehicle-mounted sensor with respect to the integrated navigation device.

14. The calibration apparatus of claim 13, wherein the processor is further configured to:
for each first timestamp offset value, determine second collection time points that differ from respective first collection time points by the first timestamp offset value;
calculate a difference value between a vehicle driving parameter value of each of the plurality of first collection time points in the first vehicle driving parameter information and a vehicle driving parameter value of a corresponding second collection time point in the second vehicle driving parameter information; and
determine, according to the calculated difference values, a cost equation value corresponding to the first timestamp offset value, and determine the cost equation value as the difference information.

15. A non-transitory computer readable storage medium, having a computer program stored thereon, wherein the computer program is run by a processor to implement a calibration method, comprising:
obtaining first vehicle driving parameter information outputted by a vehicle-mounted sensor and second vehicle driving parameter information outputted by an integrated navigation device during driving of a target vehicle; and
determining calibration parameter information of the vehicle-mounted sensor according to first vehicle driving parameter values of a plurality of first collection time points in the first vehicle driving parameter information and second vehicle driving parameter values of a plurality of second collection time points in the second vehicle driving parameter information.

16. The non-transitory computer readable storage medium of claim 15, wherein determining the calibration parameter information of the vehicle-mounted sensor according to first vehicle driving parameter values of the plurality of first collection time points in the first vehicle driving parameter information and second vehicle driving parameter values of the plurality of second collection time points in the second vehicle driving parameter information comprises:
determining a timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information;
determining, according to the determined timestamp offset value, a mapping relationship between the plurality of first collection time points for collecting the first vehicle driving parameter information and the plurality of second collection time points for collecting the second vehicle driving parameter information; and
determining the calibration parameter information of the vehicle-mounted sensor according to the determined mapping relationship, the first vehicle driving parameter values of the plurality of first collection time points in the first vehicle driving parameter information, and the second vehicle driving parameter values of the plurality of second collection time points in the second vehicle driving parameter information.

17. The non-transitory computer readable storage medium of claim 16, wherein determining the calibration parameter information of the vehicle-mounted sensor according to the determined mapping relationship, the first vehicle driving parameter values of the plurality of first collection time points in the first vehicle driving parameter information and the second vehicle driving parameter values of the plurality of second collection time points in the second vehicle driving parameter information comprises:
generating, according to the determined mapping relationship, a first vehicle driving parameter matrix comprising the first vehicle driving parameter values and a second vehicle driving parameter matrix comprising the second vehicle driving parameter values, wherein a position of a first vehicle driving parameter value of a first collection time point in the first vehicle driving parameter matrix is the same as that of a second vehicle driving parameter value of a second collection time point having a mapping relationship with the first collection time point in the second vehicle driving parameter matrix; and
generating a matrix equation by taking a calibration parameter matrix as a variable, and the first vehicle driving parameter matrix and the second vehicle driving parameter matrix as known quantities, solving the matrix equation by using a least square method to obtain the calibration parameter matrix, and determining the obtained calibration parameter matrix as the calibration parameter information.

18. The non-transitory computer readable storage medium of claim 17, wherein generating the matrix equation by taking the calibration parameter matrix as a variable, and the first vehicle driving parameter matrix and the second vehicle driving parameter matrix as known quantities, solving the matrix equation by using the least square method to obtain the calibration parameter matrix comprises:
generating the matrix equation by taking a linear velocity calibration parameter matrix as a variable, and a first linear velocity matrix in the first vehicle driving parameter information and a second linear velocity matrix in the second vehicle driving parameter information as known quantities, and solving the matrix equation by using the least square method to obtain the linear velocity calibration parameter matrix.

19. The non-transitory computer readable storage medium of claim 17, wherein generating the matrix equation by taking the calibration parameter matrix as a variable, and the first vehicle driving parameter matrix and the second vehicle driving parameter matrix as known quantities, solving the matrix equation by using the least square method to obtain the calibration parameter matrix comprises:
generating the matrix equation by taking an angular velocity calibration parameter matrix as a variable, and a first angular velocity matrix in the first vehicle driving parameter information and a second angular velocity matrix in the second vehicle driving parameter information as known quantities, and solving the matrix equation by using the least square method to obtain the angular velocity calibration parameter matrix.

20. The non-transitory computer readable storage medium of claim 16, wherein determining the timestamp offset value of the vehicle-mounted sensor with respect to the integrated navigation device according to the first vehicle driving parameter values of the plurality of first collection time points in the first vehicle driving parameter information and the second vehicle driving parameter values of the plurality of second collection time points in the second vehicle driving parameter information comprises:
determining difference information between the first vehicle driving parameter information and the second vehicle driving parameter information at each first timestamp offset value of a preset first timestamp offset value set according to the first timestamp offset value set, the first vehicle driving parameter value of each first collection time point in the first vehicle driving parameter information, and the second vehicle driving parameter value of each second collection time point in the second vehicle driving parameter information, wherein an interval between adjacent first timestamp offset values in the first timestamp offset value set is a first preset time length;
selecting a target first timestamp offset value that minimizes a difference between the first vehicle driving parameter information and the second vehicle driving parameter information from the first timestamp offset value set according to the difference information;
determining a second timestamp offset value set according to the target first timestamp offset value, wherein an intermediate value of a timestamp offset range corresponding to the second timestamp offset value set is the target first timestamp offset value, an interval between adjacent second timestamp offset values is a second preset time length, and the second preset time length is less than the first preset time length; and
taking the second timestamp offset value set as a new first timestamp offset value set, returning to determine the difference information between the first vehicle driving parameter information and the second vehicle driving parameter information at each first timestamp offset value of the first timestamp offset value set until a preset iterative condition is satisfied, and using a finally obtained target first timestamp offset value as the determined timestamp offset value of the vehicle-mounted sensor with respect to the integrated navigation device.
